(19) United States
(12) Patent Application Publication
(10) Pub. No.: US 2026/0086561 A1
(43) Pub. Date: Mar. 26, 2026

(54) METHOD AND SYSTEM FOR DOCKING A ROBOTIC MOWER WITH A CHARGING STATION

(71) Applicant: Greenworks (Jiangsu) Co., Ltd., Changzhou (CN)

(72) Inventors: Andre Lundkvist, Habo (SE); Stefan Strandberg, Jonkoping (SE); Amir Mustedanagic, Huskvarna (SE); Lucas Magnusson, Jonkoping (SE)

(21) Appl. No.: 19/408,421

(22) Filed: Dec. 4, 2025

Related U.S. Application Data
(63) Continuation of application No. PCT/CN2023/099262, filed on Jun. 9, 2023.

(51) Int. Cl. G05D 1/249; A01D 34/00; A01D 101/00; B60L 53/36; G05D 1/661; G05D 105/15; G05D 111/10; G05D 111/40

(52) U.S. Cl. CPC G05D 1/249; A01D 34/008; B60L 53/36; G05D 1/661; A01D 2101/00; B60L 2200/36; G05D 2105/15; G05D 2111/10; G05D 2111/40

(57) ABSTRACT

A method and a system for docking a robotic mower with a charging station is disclosed wherein the robotic mower comprises a control unit, a Real-Time Kinematic, RTK, unit, and a sensor and the charging station comprises a signal generator (6) and two near field wire loops. The system is configured to generate two synchronous near fields in the two near field wire loops, the near fields having magnetic fields in different directions and wherein the magnetic field is zero in between the two synchronous near fields, instruct the robotic mower to return to the charging station, navigate the robotic mower to a predetermined position using RTK, detect the near fields, navigate towards the zero magnetic field between the two near fields, and continue to navigate the robotic mower towards the charging station by following the zero magnetic field to dock with the charging station.

### CROSS REFERENCE TO RELATED APPLICATIONS

The present application is a Continuation Application of PCT Application No. PCT/CN2023/099262 filed on Jun. 9, 2023, the contents of which are incorporated herein by reference in their entirety.

### TECHNICAL FIELD

The present invention relates generally to a method and a system for docking a robotic mower with a charging station, and specially a method and system wherein the robotic mower comprises a Real-Time Kinematic Unit, RTK.

### BACKGROUND ART

In prior art there are many different methods relating to robotic mowers describing how the robotic mower is supposed to return to and dock with the charging station when it is time to charge the robotic mower. There are guide wires that the robotic mower can follow or use the Global Positioning System, GPS, or which has been growing in popularity over the past years the use of RTK, which is a much more precise system than GPS.

WO2021/188028 discloses a robotic working tool system and method using a navigation arrangement comprising a stationary base RTK unit and a mobile RTK unit adapted to move with and provide positioning data to the robotic working tool. Using RTK makes it easier to navigate and control the robotic working tool within a working area. However, there may be blind spots within the working area of the robotic working tool where the RTK coverage is lost. This is especially true when it comes navigating the robotic working tool to the charging station, which often is situated at a secluded place with poor RTK coverage.

It is therefore a need to improve the control of a robotic mower when returning to and docking with the charging station, especially in situations where the charging station has poor RTK coverage.

### SUMMARY OF INVENTION

An object of the present invention is to achieve a method for controlling the robotic mower to a precise and reliable docking with the charging station.

This is accomplished with a method for docking a robotic mower with a charging station, wherein the robotic mower comprises a control unit, a Real-Time Kinematic, RTK, unit, and a sensor and the charging station comprises a signal generator and two near field wire loops. The method comprises generating, by means of the signal generator and the two near field wire loops, two synchronous near fields having magnetic fields in different directions and wherein the magnetic field is zero in between the two synchronous near fields; instructing, by means of the control unit, the robotic mower to return to the charging station; navigating, by means of the control unit and the RTK unit, the robotic mower to a predetermined position; detecting, by means of the sensor, the near fields; navigating, by means of control unit and the sensor, towards the zero magnetic field between the two near fields, and navigating, by means of the control unit and the sensor, the robotic mower towards the charging station by following the zero magnetic field to dock with the charging station.

In an exemplary embodiment the predetermined position is within the generated near field.

In another exemplary embodiment the charging station further comprises a far field wire loop and the method further comprises, generating, by means of the signal generator and the far field wire loop, a far field, and navigating, by means of the control unit and the sensor, the robotic mower towards a higher far field strength. In this case the predetermined position is within the generated far field.

In yet another exemplary embodiment the robotic mower further comprises a camera having stored an image of the shape of the charging station, and the method further comprises starting the camera when reaching the predetermined position and assisting the navigation of the robotic mower, by means of the control unit and the camera, towards docking the robotic mower with the charging station to dock with charging station by matching the stored image with the camera's field of view.

In another exemplary embodiment the charging station is instead provided with a sticker, and the method further comprises starting the camera when reaching the predetermined position and assisting the navigation of the robotic mower, by means of the control unit and the camera, towards docking the robotic mower with the charging station to dock with charging station by identifying the sticker with the camera, and navigating, by means of the control unit and the camera, the robotic mower towards the sticker.

In another exemplary embodiment the navigating, by means of control unit and the sensor, towards the zero magnetic field between the two near fields is performed with a sensor positioned in the middle of the robotic mower.

Another object of the present invention is to achieve a system for controlling the robotic mower to a precise and reliable docking with the charging station.

This is accomplished by a system for docking a robotic mower with a charging station, comprising the robotic mower provided with a control unit, a Real-Time Kinematic, RTK, unit, and a sensor and the charging station provided with a signal generator and two near field wire loops, wherein the control unit comprises a processor and a memory, the memory comprising instructions which when executed by the processer causes the system to generate, by means of the signal generator and the two near field wire loops, two synchronous near fields having magnetic fields in different directions and wherein the magnetic field is zero in between the two synchronous near fields; instruct, by means of the control unit, the robotic mower to return to the charging station; navigate, by means of the control unit and the RTK unit, the robotic mower to a predetermined position; detect, by means of the sensor, the near fields, navigate, by means of control unit and the sensor, towards the zero magnetic field between the two near fields, and navigate, by means of the control unit and the sensor, the robotic mower towards the charging station by following the zero magnetic field to dock with the charging station.

In an exemplary embodiment the predetermined position is within the generated near field.

In another exemplary embodiment the charging station further comprises a far field wire loop and is further configured to cause the system to generate, by means of the signal generator and the far field wire loop, a far field, and navigate, by means of the control unit and the sensor, the robotic mower towards a higher far field strength. In this case the predetermined position is within the generated far field.

In yet another embodiment the robotic mower further comprises a camera having stored an image of the shape of the charging station and the system is further configured to start the camera when reaching the predetermined position and assist the navigation of the robotic mower, by means of the control unit and the camera, towards docking the robotic mower with the charging station to dock with the charging station by matching the stored image with the camera's field of view.

In another exemplary embodiment the charging station is provided with a sticker, and the system is further configured to start the camera when reaching the predetermined position and assist the navigation of the robotic mower, by means of the control unit and the camera, towards docking the robotic mower with the charging station to dock with the charging station by identifying the sticker with the camera, and control, by means of the control unit and camera, the robotic mower towards the sticker.

In an exemplary embodiment the sensor is positioned in the middle of the robotic mower.

In another exemplary embodiment the far field wire loop has a substantially rectangular shape covering a main part of a bottom plate of the charging station.

In an exemplary embodiment the two near field wire loops together form an eight-like shape, which preferably are provided inside the far filed wire loop.

In another exemplary embodiment a computer program is accomplished which comprises computer program code, the computer program code being adapted, if executed by the processer of the control unit, to implement the method of the present invention.

One of the advantages with the method and system of the present invention is that one may use the accuracy of an RTK system when controlling the robotic mower, but if RTK coverage is poor, for example in the vicinity of the charging station, it will still be possible to dock the robotic mower with the charging station using the two generated synchronous near fields. In addition, thereto it is furthermore according to preferred embodiments also possible to use a generated far field to control the robotic mower in its docking process with the charging station. This further increases the area within which the robotic over can start its docking process even if there is poor RTK coverage.

With the use of a camera provided on the robotic mower it is possible to further expand the within which the robotic mower successfully may dock when RTK coverage is lost.

### BRIEF DESCRIPTION OF DRAWINGS

The invention is now described, by way of example, with reference to the accompanying drawings, in which:

FIG. 1 is a schematic view of a robotic mower and a charging station.

FIG. 2 is a schematic view of the robotic mower and its different components.

FIG. 3 is a schematic view of the charging station and its different components.

FIG. 4 is a schematic view of the control unit and its different parts.

FIG. 5 is a schematic view of a far field generated by a far field wire loop.

FIG. 6 is a schematic view of a near fields generated by two synchronous near field wire loops.

FIG. 7 is a flow chart showing the method of the present invention.

FIG. 8 is a flow chart showing an exemplary embodiment of the method.

FIG. 9 is a flow chart showing another exemplary embodiment of the method.

### DESCRIPTION OF EMBODIMENTS

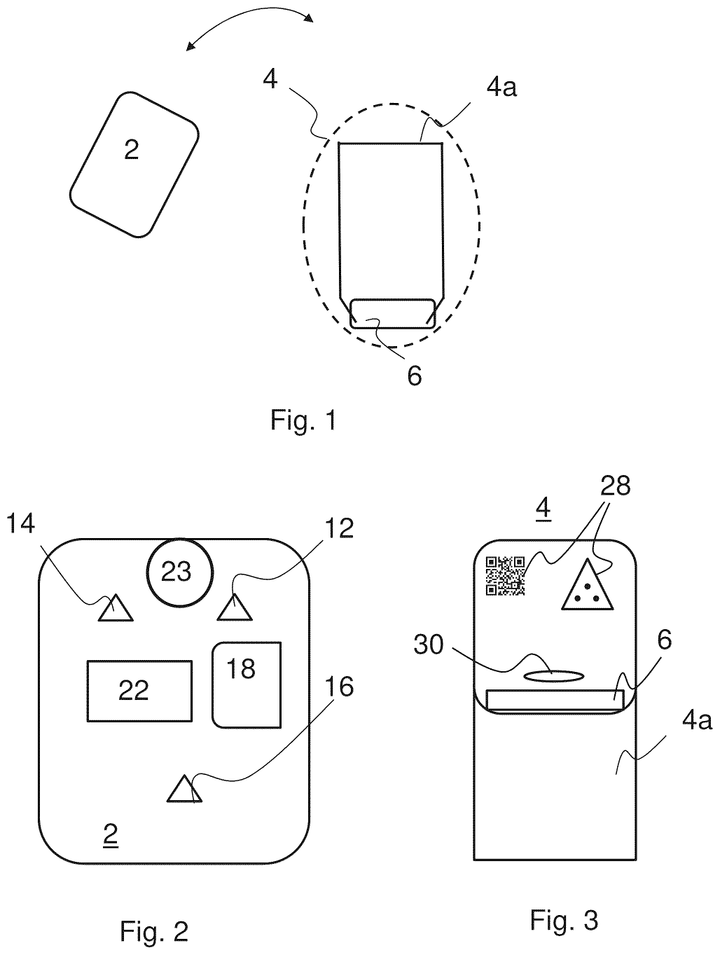

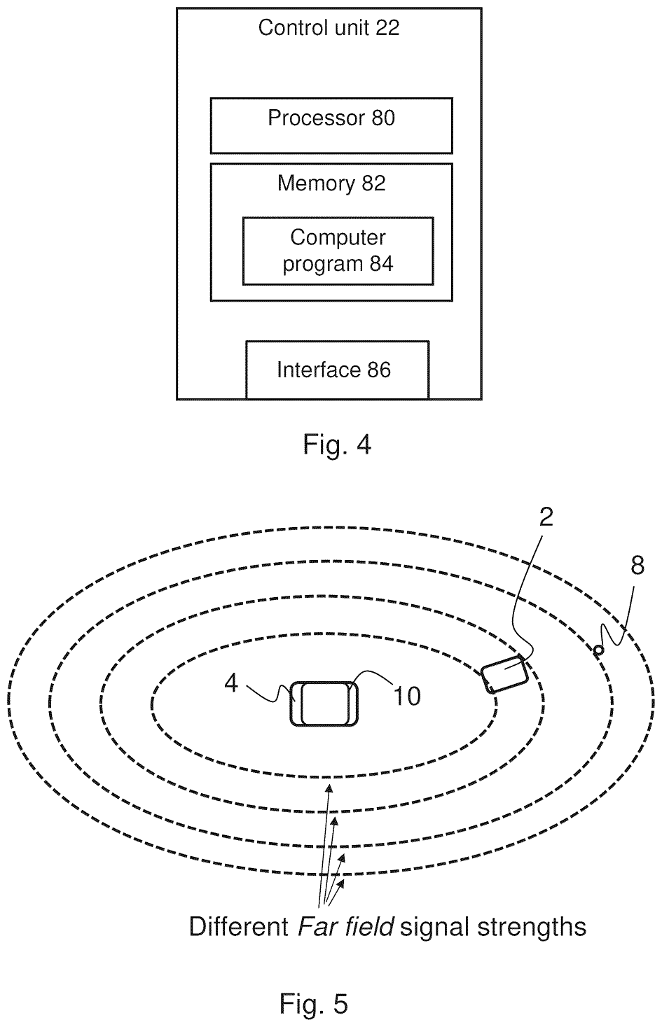

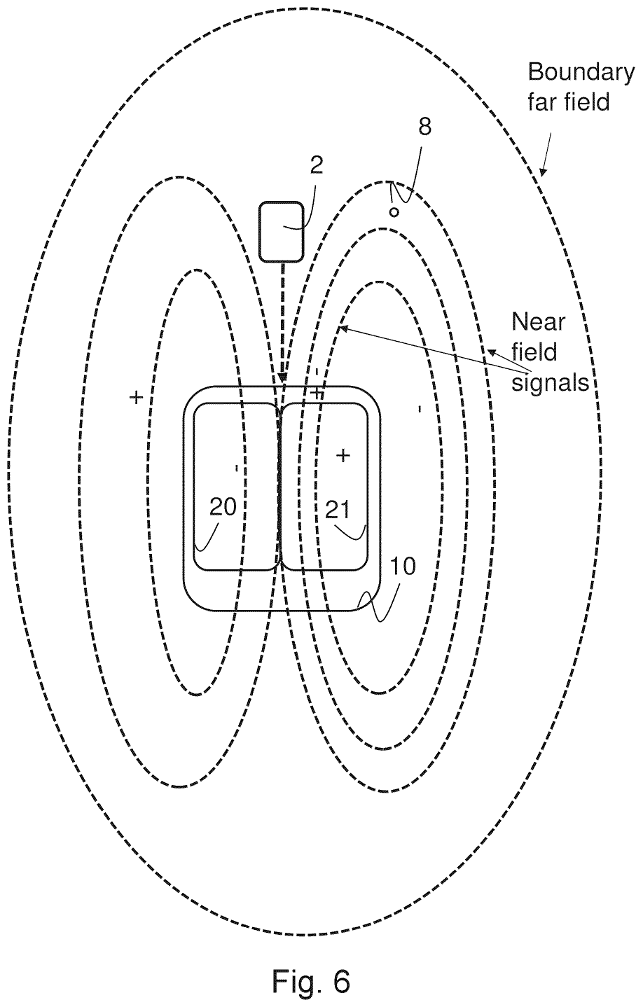

In the following, a detailed description of method and the system for docking a robotic mower with a charging station. FIG. 1 shows a schematic view of a robotic mower 2 and a charging station 4. The robotic mower 2, which is shown in more detail in FIG. 2, comprises a control unit 22, at least one sensor 12, 14 and/or 16, a TRK unit 18, a battery (not shown) and optionally also a camera 23. The control unit 22, which will be closer described in conjunction with FIG. 4, comprises among other things a processor 80 for controlling the movement of the robotic mower 2. The charging station 4, which is shown in more detail in FIG. 3, comprises a signal generator 6, a charging contact 30, a bottom plate 4a and optionally stickers 28, which could represent a QR code or some pattern that is recognizable by the camera 23. The charging station 4 is also provided with two near field wire loops 20, 21 (shown in FIG. 6) and optionally also a far field loop 10 (shown in FIG. 5).

Turning now to FIG. 4, the control unit 22 of the robotic mower 2 will be closer described. The control unit 22 comprises, as mentioned above the processor 80 and a memory 82. The memory 82 may comprise a computer program 84 comprising computer program code, i.e. instructions. The computer program code is adapted to implement the method steps performed by the robotic mower 2 when the code is executed on the processor 80. The control unit 22 further comprises an interface 86 for communication with the sensors 12, 14 and 16, and a motor that operates the robotic mower 2.

The processor 80 may comprise a single Central Processing Unit (CPU) or could comprise two or more processing units. For example, the processor 80 may include general purpose microprocessors, instruction set processors and/or related chips sets and/or special purpose microprocessors such as Application Specific Integrated Circuits (ASICs), Field Programmable Gate Arrays (FPGAs) or Complex Programmable Logic Devices (CPLDs). The processor 80 may also comprise a storage for caching purposes.

The system for docking the robotic mower 2 with the charging station 4, comprises the robotic mower 2 provided with the control unit 22, the RTK unit 18, and at least one sensor 16 and the charging station 4 provided with a signal generator 6 and two near field wire loops 20; 21. The control unit 22 comprises the processor 80 and the memory 82. The memory 82 comprises instructions which when executed by the processer 80 causes the system to generate, by means of the signal generator 6 and the two near field wire loops 20, 21, two synchronous near fields having magnetic fields in different directions and wherein the magnetic field is zero in between the two synchronous near fields. When the robotic mower 2 is instructed, by means of the control unit 22, the robotic mower 2 to return to the charging station 4, i.e. when it is time to charge the battery of the robotic mower 2 or when the robotic mower has finished mowing the grass, the robotic mower 2 is caused to navigate, by means of the control unit 22 and the RTK unit 18, to a predetermined position 8. In a preferred embodiment the predetermined position 8 is within the generated near fields, which is shown in detail in FIG. 6. The predetermined position 8 is a preprogrammed position that is stored in the control unit 22 and which is known to be within the boundaries of the near fields, and which is also known to have good RTK coverage such that the robotic mower 2 is navigable to the predetermined position 8 using RTK.

When the predetermined position 8 is reached the robotic mower 2 is caused to detect, by means of the sensor 16, the near fields, and navigate, by means of control unit 22 and the sensor 16, towards the zero magnetic field between the two near fields, and navigate, by means of the control unit 22 and the sensor 16, the robotic mower 2 towards the charging station 4 by following the zero magnetic field to dock with the charging station 4. The two near fields are connected in such a way that they will generate magnetic fields in different directions at the same time. This will result in that it looks like the magnetic field is zero in between the two near fields. The robotic mower 2 can then navigate along that zero-field, by using the sensor 16, which is placed in the middle of the robotic mower 2. It is also possible to instead use two sensor 12, 14 to detect the zero-field. In order to get this zero-field, the near fields are generated synchronous. In one embodiment the two near field wire loops 20, 21 together form an eight-like shape. They can be two separate near field wire loops 20, 21 that together form the eight or be a single wire loop that forms the eight.

In another embodiment the charging station 4 further comprises a far field wire loop 10, see FIG. 5 and also FIG. 6, provided on the bottom plate 4a of the charging station. In a preferred embodiment the charging station 4 comprises both the far field wire loop 10 and the two near field wire loops 20, 21. Preferably the two near field wire loops 20, 21 are provided inside the far filed wire loop 10. The far field wire loop 10 has a substantially rectangular shape covering a main part of a bottom plate 4a of the charging station 4.

When using the far field wire loop 10 the system is further configured to generate, by means of the signal generator 6 and the far field wire loop 10, a far field. In this embodiment the predetermined position 8 is within the far field and when the robotic mower 2 reaches the predetermined position 8, it is caused to navigate, by means of the control unit 22 and the sensor 16, towards a higher far field strength, i.e. closer to the charging station 4. When the robotic mower 2 progresses further and closer to the charging station 4 it will detect the near field signals and commence as described above in conjunction with the robotic mower 2 reaching a predetermined position 8 within the near fields.

In another exemplary embodiment the robotic mower 2 further comprises a camera 2 to further assist the robotic mower 2 in navigating towards docking with the charging station 4. The camera 23 has an image of the shape of the charging station 2 stored and is in this exemplary embodiment further configured to start the camera 23 when reaching the predetermined position 8 and assist the navigation of the robotic mower 2, by means of the control unit 22 and the camera 23, towards docking the robotic mower 2 with the charging station 4 to dock with charging station. This is done by matching the stored image with the camera's 23 field of view. In an alternative embodiment the charging station is provided with a sticker 28, representing a QR code, a bar code or a pattern and assist the navigation of the robotic mower 2, by means of the control unit 22 and the camera 23, towards docking the robotic mower 2 with the charging station 4 to dock with charging station 4 by identifying the sticker 28 with the camera 23, and control, by means of the control unit 22 and camera 23, the robotic mower 2 towards the sticker 28

Turning now again to FIG. 6, showing both the near field signals and the far field signals (only boundary thereof) the behavior of the robotic mower 2 close to the charging station 4 will be described. When the robotic mower 2 has progressed even further and closer to the charging station 4, the robotic mower 2 will detect that it passes the actual far field wire loop 10. This information will prepare the robotic mower 2 for the fact that it will soon also pass the near field wire loops 20, 21. As long as the robotic mower 2 is positioned outside the far field wire loop 10 the polarity of the near fields and it is easy to navigate along the zero line. The far field wire loop is in an exemplary embodiment provided 20 cm from the near field wire loops 20, 21. When passing the far field wire loop 10, the far field changes its polarity and the control unit 22 of the robotic mower 2 will know that soon also the near fields will change polarity. During the short distance between the far field wire loop 10 and the near field wire loops 20, 21 the senor 16 may have difficult to adequately sense the different fields, which means that between the actual far field wire loop 10 and the near field wire loops 20, 21 the robotic mower 2 may use dead reckoning for a short distance when navigating. However, according to the exemplary embodiments that comprise the camera 23, the camera 23 may be used to assist the robotic mower 2 in navigation towards docking with the charging station 4.

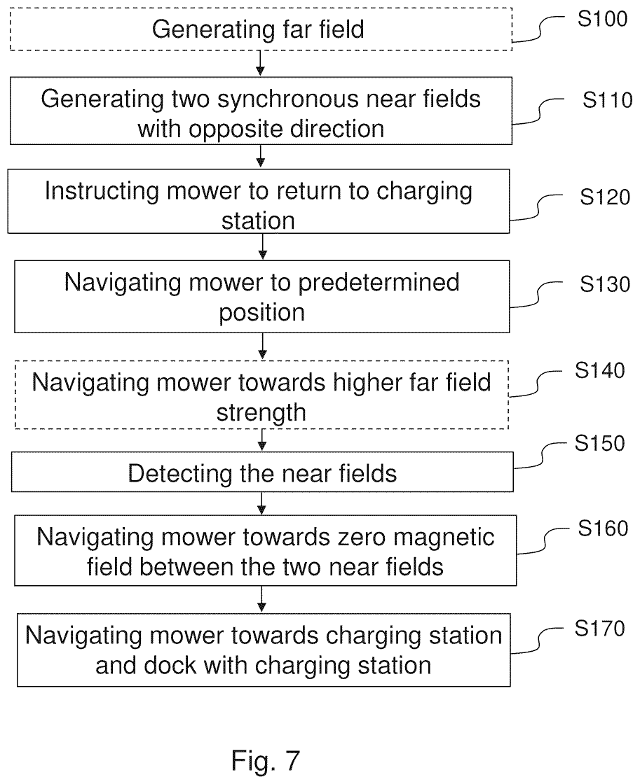

With reference to FIG. 7 the method according to the present invention will be closer described. FIG. 7 shows the different method steps and in which optional steps are shown with dashed lines. In step S110 the signal generator generates two synchronous near fields in the two near field wire loops 20; 21 having magnetic fields in different directions and wherein the magnetic field is zero in between the two synchronous near fields. In step S120 the control unit 22 instructs the robotic mower 2 to return to the charging station 4. This instruction may be issued by the control unit 22 when it has detected that thit is time to recharge the battery of the robotic mower 2, when the robotic mower 2 has fished mowing or due to bad weather conditions. In step S130 the control unit 22 and the RTK unit 18 navigates the robotic mower 2 to a predetermined position 8. When the sensor 16 in step S150 detects the near fields, the control unit 22 and the sensor 16, in step S160, navigates the robotic mower 2 towards the zero magnetic field between the two near fields, and in step S170 continues to navigate, by means of the control unit 22 and the sensor 16, the robotic mower 2 towards the charging station 4 by following the zero magnetic field to dock with the charging station 4.

As mentioned above the predetermined position 8 is a preprogrammed position that is stored in the control unit 22 and which is known to be within the boundaries of the near fields, and which is also known to have good RTK coverage such that the robotic mower 2 is navigable to the predetermined position 8 using RTK.

In an exemplary embodiment the charging station 4 further comprises a far field wire loop 10 and the method further comprises generating, in step S100, a far field with the signal generator 6 and the far field wire loop 10. In step S140 the control unit 22 and the sensor 16 navigates the robotic mower 2 towards a higher far field strength and continues further and closer to the charging station 4 until the sensor 16 detects the near field signals and commences as described above in conjunction with the robotic mower 2 reaching a predetermined position 8 within the near fields.

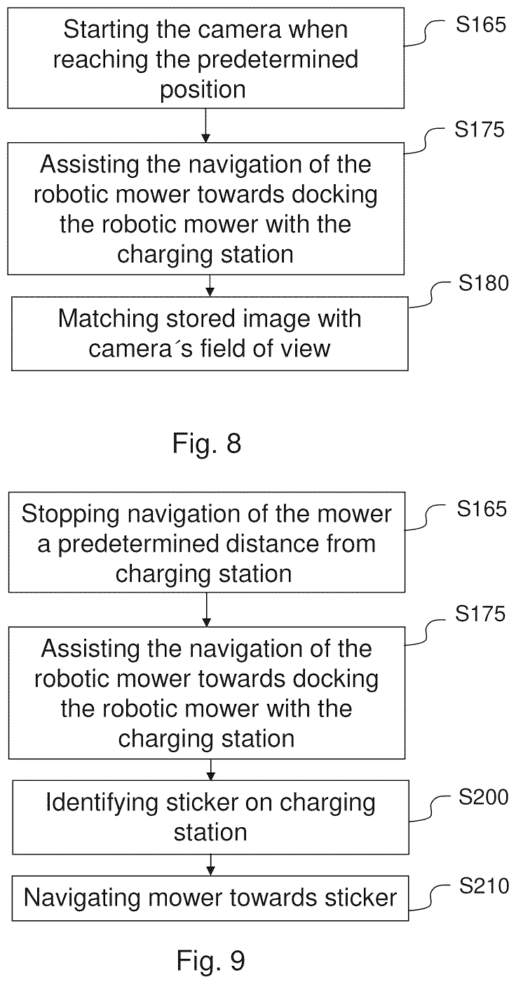

In another exemplary method, shown in FIG. 8, the robotic mower 2 further comprises a camera 23 having stored an image of the shape of the charging station 4, and the method further comprises starting, in step S165, the camera 23 when reaching the predetermined position 8 and, in step S175, assisting the navigation of the robotic mower 2, by means of the control unit 22 and the camera 23, towards docking the robotic mower 2 with the charging station 4 to dock with charging station 4 by, in step S180 matching the stored image with the camera's 23 field of views

In an alternative embodiment of using the camera 23 the charging station 4 is provided with a sticker 28, represented by a QR code, a bar code or a pattern and as shown in FIG. 9, the method further comprises starting, in step S165, the camera 23 when reaching the predetermined position 8 and, in step S175, assisting the navigation of the robotic mower 2, by means of the control unit 22 and the camera 23, towards docking the robotic mower 2 with the charging station 4 to dock with charging station 4 by identifying, in step S200 the sticker 28 with the camera 23, and navigating, in step S210, by means of the control unit 22 and the camera 23, the robotic mower 2 towards the sticker 28.

The present invention also relates to a computer program product 84 comprising computer program code, the computer program code being adapted, if executed by the processer 80 of the control unit 22, to implement the method according to the present invention.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein and are intended to be encompassed hereby.

1. A method for docking a robotic mower (2) with a charging station (4), wherein the robotic mower (2) comprises a control unit (22), a Real-Time Kinematic, RTK, unit (18), and a sensor (16) and the charging station (4) comprises a signal generator (6) and two near field wire loops (20; 21), the method comprising:
generating (S110), by means of the signal generator (6) and the two near field wire loops (20; 21), two synchronous near fields having magnetic fields in different directions and wherein the magnetic field is zero in between the two synchronous near fields,
instructing (S120), by means of the control unit (22), the robotic mower (2) to return to the charging station (4),
navigating (S130), by means of the control unit (22) and the RTK unit (18), the robotic mower (2) to a predetermined position (8),
detecting (S150), by means of the sensor (16), the near fields,
navigating (S160), by means of control unit (22) and the sensor (16), towards the zero magnetic field between the two near fields, and
navigating (S170), by means of the control unit (22) and the sensor (16), the robotic mower (2) towards the charging station (4) by following the zero magnetic field to dock with the charging station (4).

2. The method according to claim 1, wherein the predetermined position (8) is within the generated near field.

3. The method according to claim 1, wherein the charging station (4) further comprises a far field wire loop (10) and the method further comprises:
generating (S100), by means of the signal generator (6) and the far field wire loop (10), a far field,
navigating (S140), by means of the control unit (22) and the sensor (16), the robotic mower (2) towards a higher far field strength.

4. The method according to claim 3, wherein the predetermined position (8) is within the generated far field.

5. The method according to claim 1, wherein the robotic mower (2) further comprises a camera (23) having stored an image of the shape of the charging station (4), the method further comprising:
starting (S165) the camera (23) when reaching the predetermined position (8) and
assisting (S175) the navigation of the robotic mower (2), by means of the control unit (22) and the camera (23), towards docking the robotic mower (2) with the charging station (4) to dock with charging station (4) by
matching (S180) the stored image with the camera's (23) field of view.

6. The method according to claim 1, wherein the robotic mower (2) further comprises a camera (23) and the charging station (4) is provided with a sticker (28), the method further comprising:
starting (S165) the camera (23) when reaching the predetermined position (8) and
assisting (S175) the navigation of the robotic mower (2), by means of the control unit (22) and the camera (23), towards docking the robotic mower (2) with the charging station (4) to dock with charging station (4) by
identifying (S200) the sticker (28) with the camera (23), and
navigating (S210), by means of the control unit (22) and the camera (23), the robotic mower (2) towards the sticker (28).

7. The method according to claim 1, wherein navigating (S160), by means of control unit (22) and the sensor (16), towards the zero magnetic field between the two near fields is performed with a sensor (16) positioned in the middle of the robotic mower (2).

8. A system for docking a robotic mower (2) with a charging station (4), comprising the robotic mower (2) provided with a control unit (22), a Real-Time Kinematic, RTK, unit (18), and a sensor (16) and the charging station (4) provided with a signal generator (6) and two near field wire loops (20; 21), wherein the control unit (22) comprises a processor (80) and a memory (82), the memory (82) comprising instructions which when executed by the processer (80) causes the system to:
generate, by means of the signal generator (6) and the two near field wire loops (20; 21), two synchronous near fields having magnetic fields in different directions and wherein the magnetic field is zero in between the two synchronous near fields,
instruct, by means of the control unit (22), the robotic mower (2) to return to the charging station (4),
navigate, by means of the control unit (22) and the RTK unit (18), the robotic mower to a predetermined position (8),
detect, by means of the sensor (16), the near fields,
navigate, by means of control unit (22) and the sensor (16), towards the zero magnetic field between the two near fields, and
navigate, by means of the control unit (22) and the sensor (16), the robotic mower (2) towards the charging station (4) by following the zero magnetic field to dock with the charging station (4).

9. The system according to claim 8, wherein the predetermined position (8) is within the generated near field.

10. The system according to claim 8, wherein the charging station (4) further comprises a far field wire loop (10) and further configured to cause the system to:
generate, by means of the signal generator (6) and the far field wire loop (10), a far field,
navigate, by means of the control unit (22) and the sensor (16), the robotic mower (2) towards a higher far field strength.

11. The method according to claim 10, wherein the predetermined position (8) is within the generated far field.

12. The system according to claim 8, wherein the robotic mower (2) further comprises a camera (23) having stored an image of the shape of the charging station and the system is further configured to:
start the camera (23) when reaching the predetermined position (8),
assist the navigation of the robotic mower (2), by means of the control unit (22) and the camera (23), towards docking the robotic mower (2) with the charging station (4) to dock with charging station (4), and
match the stored image with the camera's (23) field of view.

13. The system according to claim 8, wherein the system further comprises a camera (23) and the charging station (6) is provided with a sticker (28), and the system is further configured to:
start the camera (23) when reaching the predetermined position (8),
assist the navigation of the robotic mower (2), by means of the control unit (22) and the camera (23), towards docking the robotic mower (2) with the charging station (4) to dock with charging station (4),
identifying the sticker (28) with the camera (23), and
control, by means of the control unit (22) and camera (23), the robotic mower (2) towards the sticker (28).

14. The system according to claim 8, wherein the sensor (16) is positioned in the middle of the robotic mower (2).

15. The system according to claim 10, wherein the far field wire loop (10) has a substantially rectangular shape covering a main part of a bottom plate (4a) of the charging station (4).

16. The system according to claim 8, wherein the two near field wire loops (20; 21) together form an eight-like shape.

17. The system according to claim 16, wherein the eight like shape of the two near field wire loops (20, 21) are provided inside the far filed wire loop (10).

18. A computer program (84) comprising computer program code, the computer program code being adapted, if executed by the processer (80) of the control unit (22), to implement the method according to claim 1.
